(19) United States
(12) Patent Application Publication
(10) Pub. No.: US 2012/0066191 A1
(43) Pub. Date: Mar. 15, 2012

(54) OPTIMIZED CONCURRENT FILE INPUT/OUTPUT IN A CLUSTERED FILE SYSTEM

(75) Inventors: Joon Chang, Austin, TX (US); Robert K. Gjertsen, Austin, TX (US); Ninad S. Palsule, Beaverton, OR (US)

(73) Assignee: International Business Machines Corporation, Armonk, NY (US)

(21) Appl. No.: 12/879,228

(22) Filed: Sep. 10, 2010

(51) Int. Cl. G06F 17/30

(52) U.S. Cl. 707/704; 707/827; 707/E17.01; 707/E17.008

(57) ABSTRACT

Embodiments include a method comprising transmitting from a node of a plurality of nodes within a clustered file system provides concurrent file I/O access for files, to write access a region of a file. The method includes receiving an authorization to write access the region without a lock to preclude access of the region by other nodes, if at least one physical section in a machine-readable medium has been allocated for storage of the region by the server. The method includes receiving the authorization to write access the region with the lock to preclude access of the region by the other nodes, if the at least one physical section in the machine-readable medium has not been allocated for storage of the region by the server. Responsive to receiving the authorization to write access, metadata is transmitted for storage into the at least one physical section in the machine-readable medium.

### BACKGROUND

Traditional non-clustered file systems (such as AIX JFS2 ((Advanced Interactive Executive Journaled File System—version 2)) support concurrent file input/output (I/O) by allowing an application to read from and write to disjoint portions of the file concurrently. In this situation, the application I/O is directly performed to the storage device and bypasses file system caching. Generally, the application has greater knowledge of its read or write patterns with concurrent file I/O than the file system. Therefore, the application can serialize operations to conflicting file regions.

Modern clustered file systems support distributed file access using a token manager. The systems generally support concurrent file I/O read or write operations from multiple nodes. However, the operations are protected by a single whole file token that results in only one node or application writing to the file at any given time, even if the write operations are to disjoint regions of the file. The token manager grants an exclusive file level token for a single node for a write operation. This in turn forces other nodes to flush their metadata cache and causes a ping-pong effect when multiple nodes are writing to the same file. In this scenario, there is a performance penalty and true concurrent file I/O is not supported.

### SUMMARY

Embodiments include a method comprising receiving a request to write access a region of a file of a plurality of files from a node of a plurality of nodes within a clustered file system. The clustered file system provides concurrent file input/output (I/O) access for the plurality of files. Responsive to determining that at least one physical section of a machine-readable medium has been allocated for storage of the region of the file, write access to the region of the file is authorized without locking the region to preclude other nodes of the plurality of nodes from access to the region. Responsive to determining that the at least one physical section of the machine-readable medium has not been allocated for storage of the region of the file and that the region is not locked from access, performing the following operations. An operation includes allocating the at least one physical section in the machine-readable medium for storage of the region of the file. Another operation includes assigning a lock for access of the region to the node, wherein the assigning of the lock for access precludes other nodes of the plurality of nodes from accessing the region. Another operation includes transmitting, to the node, an address range of the at least one physical section in the machine-readable medium. Another operation includes receiving, back from the node, data for storage into the at least one physical section in the machine-readable medium. Another operation includes releasing the lock to enable access to the region by other nodes of the plurality of nodes, after storing the data into the at least one physical section in the machine-readable medium.

Embodiments include a method comprising transmitting, to a server and from a node of a plurality of nodes within a clustered file system provides concurrent file input/output (I/O) access for a plurality of files, to write access a region of a file of the plurality of files. The method also includes receiving, back from the server and by the node, an authorization to write access the region without a lock to preclude access of the region by other nodes of the plurality of nodes, if at least one physical section in a machine-readable medium has been allocated for storage of the region by the server. The method includes receiving, back from the server and by the node, the authorization to write access the region with the lock to preclude access of the region by the other nodes, if the at least one physical section in the machine-readable medium has not been allocated for storage of the region by the server. Responsive to receiving the authorization to write access, data is transmitted to the server and from the node for storage into the at least one physical section in the machine-readable medium.

Embodiments include a computer program product for concurrent access of a plurality of files. The computer program product comprises a computer readable storage medium having computer readable program code embodied therewith. The computer readable program code is configured to receive a request to write access a region of a file of the plurality of files from a node of a plurality of nodes within a clustered file system. The clustered file system provides concurrent file input/output (I/O) access for the plurality of files. Responsive to determining that at least one physical section of a machine-readable medium has been allocated for storage of the region of the file, the computer readable program code is configured to authorize the write access to the region of the file without locking the region to preclude other nodes of the plurality of nodes from access to the region. Responsive to determining that the at least one physical section of the machine-readable medium has not been allocated for storage of the region of the file and that the region is not locked from access, the computer readable program code is configured to perform the following operations. An operation includes allocate the at least one physical section in the machine-readable medium for storage of the region of the file. Another operation includes assign a lock for access of the region to the node, wherein the assigning of the lock for access precludes other nodes of the plurality of nodes from accessing the region. Another operation includes transmit, to the node, an address range of the at least one physical section in the machine-readable medium. Another operation includes receive, back from the node, data for storage into the at least one physical section in the machine-readable medium. Another operation includes release the lock to enable access to the region by other nodes of the plurality of nodes, after storing the data into the at least one physical section in the machine-readable medium.

Embodiments include an apparatus comprising a processor that is part of a node of a plurality of nodes. The apparatus includes an access module executable on the processor. The access module is configured to transmit, to a server within a clustered file system that provides concurrent file input/output (I/O) access for a plurality of files, to write access a region of a file of the plurality of files. The access module is configured to receive, back from the server, an authorization to write access the region without a lock to preclude access of the region by other nodes of the plurality of nodes, if at least one physical section in a machine-readable medium has been allocated for storage of the region by the server. The access module is configured to receive, back from the server, the authorization to write access the region with the lock to preclude access of the region by the other nodes, if the at least one physical section in the machine-readable medium has not been allocated for storage of the region by the server. Responsive to receipt of the authorization to write access, the access module is configured to transmit, to the server, data for storage into the at least one physical section in the machine-readable medium.

### BRIEF DESCRIPTION OF THE DRAWINGS

The present embodiments may be better understood, and numerous objects, features, and advantages made apparent to those skilled in the art by referencing the accompanying drawings.

FIG. 1 is diagram illustrating message exchange among a metadata server and multiple nodes when allocation is needed for a new section of a file being concurrently accessed, according to some example embodiments.

FIG. 2 is diagram illustrating message exchange among a metadata server and multiple nodes when allocation is not needed for sections of a file being concurrently accessed, according to some example embodiments.

FIG. 3 is a flowchart illustrating operations, executed by a metadata server, for concurrent file I/O access, according to some example embodiments.

FIG. 4 is a flowchart illustrating operations, executed by a client node, for concurrent file I/O access, according to some example embodiments.

FIG. 5 is a block diagram of a clustered file system having concurrent access, according to some example embodiments.

FIG. 6 is a block diagram illustrating a computer system, according to some example embodiments.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. In other instances, well-known instruction instances, protocols, structures, and techniques have not been shown in detail in order not to obfuscate the description.

Some example embodiments more efficiently support true concurrent file I/O in a clustered file system. A metadata server can manage concurrent access to files by multiple client nodes of a clustered file system when new block allocation is performed for the files. The metadata server can mediate access to a file region related to a new block allocation (e.g., a physical block on a disk). For example, assume a client node A wants to append new data to the end of a file. The metadata server can mediate or manage access to the file by other nodes of a cluster while the client node A obtains the physical block(s) in a machine-readable medium for storing the new data appended to the file by the client node A. In contrast to conventional techniques, the metadata server can manage access to the file without transmitting tokens for the region (e.g., byte ranges) of the file corresponding to the newly allocated block(s)to the client node A.

Also, lock access to allow only one client node access to a region of a file can be limited to certain situations. Locking can be limited to when a physical section in a machine-readable medium has not been previously allocated for a region of a file (i.e., limited to when the region is not backed). Therefore, serialization of access can be limited to times when allocation of a physical block for storage to the region of the file is needed. Also, as noted above and further described below, client nodes do not receive and manage tokens for the regions of the file. Rather, this management of access is maintained by the metadata server. Such a configuration reduces lock management overhead and communication between clients and the metadata server. Also, such a configuration obviates token management on the client node and limits the token management to the metadata server. Once new physical sections on a machine-readable medium are allocated and the exclusive token is released by the metadata server, then read and write accesses to the same regions of a file can be performed concurrently without token exchange among the nodes. Instead of burdening the file system at client nodes and/or the metadata server, application level-locking or serialization resolves concurrent access by multiple client nodes to a same region of a file already backed with allocated blocks.

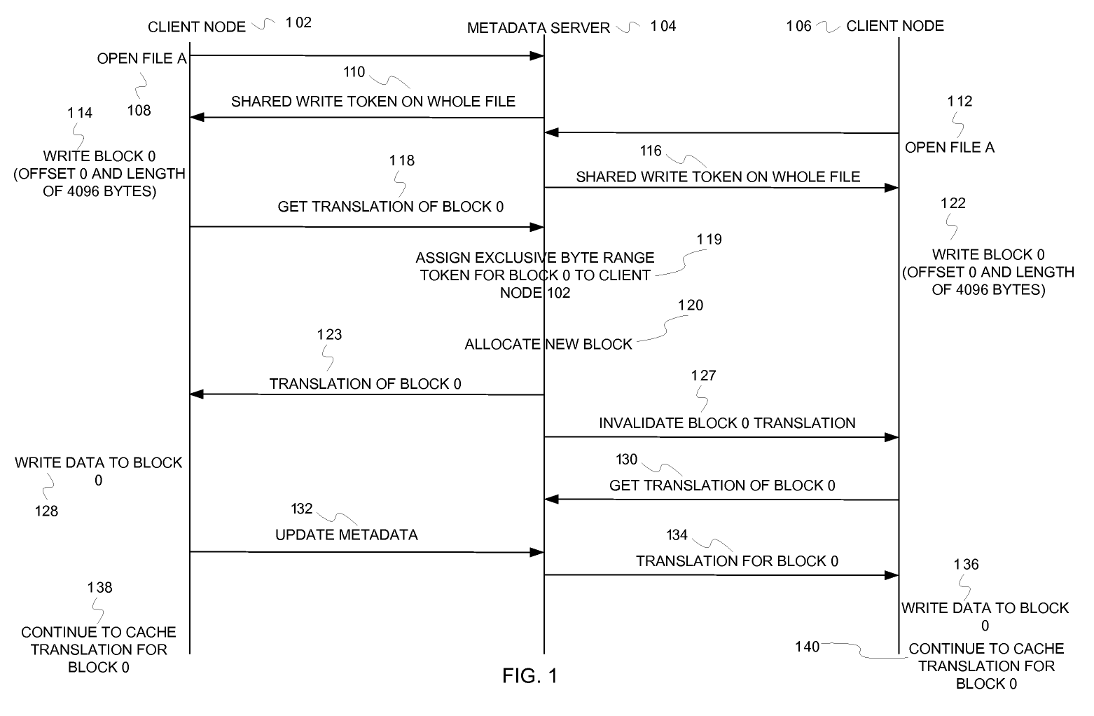

FIG. 1 is diagram illustrating message exchanges and operations among a metadata server and multiple nodes when allocation is needed for a new region of a file being concurrently accessed in a clustered file system, according to some example embodiments. FIG. 1 includes a metadata server 104 that can be part of a clustered file system to support distributed file access, wherein the file system is simultaneously mounted on multiple client nodes. The metadata server 104 maintains a file hierarchy or inodes of the clustered file system, and regulates access to files of the clustered file system. The metadata server 104 can be representative of a centralized metadata server of a clustered file system. Alternatively, the metadata server 104 can be representative of a partition of a shared device in the clustered file system.

FIG. 1 also includes two client nodes (a client node 102 and a client node 106) that can concurrently access the files stored in clustered file system. The client nodes 102 and 106 can be representative of any type of client device (e.g., desktop computers, laptop computers, various mobile computing devices (such as, wireless Personal Digital Assistants (PDAs), wireless phones, etc.), etc.).

FIG. 1 illustrates, over time, a series of operations executing on and various messages between the metadata server 104, the client device 102 and the client device 106. In particular, time begins at the top of the diagram of FIG. 1. Time continues as the operations and messages descend down the diagram of FIG. 1. Therefore, in this example application, an operation 108 and an operation 140 are first and last in time, respectively.

The client node 102 opens file A that is concurrently accessible by multiple nodes (108). As part of the opening of file A, the client node 102 transmits a request to metadata server 104 to open file A. In response, the metadata server 104 transmits a shared write token for the whole file A (110) after determining that the file named in the request exists. This shared write token does not lock file A. Rather, each client node that opens file A has a shared write token on the whole file so that multiple reads and writes from and to the file in different regions can be performed in parallel from any node. In other words, each client node accessing file A is assigned a shared write token over the whole file range and read/write requests are permitted with this token except when a new backing storage allocation is required (as further described below).

Next in time, the client node 106 also opens file A (112). As part of the opening of file A, the client node 106 transmits a request to metadata server 104 to open file A after determining that the file named in the request exists. In response, the metadata server 104 transmits a shared write token for the whole file A (116). Accordingly, two different client nodes have a shared write token on the whole file A at a same time.

Next in time, the client node 102 writes to block 0 at an offset of 0 and having a length of 4096 bytes in the file A (114). This involves the client node 102 obtaining a translation of logical block 0 from the metadata server 104 (118). In particular, the translation provides location of a physical block that backs the logical block 0 with a range of 4096 bytes. In this example, a physical block has not been allocated within a machine-readable medium for the logical block 0 and the range of 4096 bytes. Because the logical block 0 is not backed with a physical block, the metadata server 104 grants an exclusive byte range token for a range of 4096 bytes from block 0 to the client node 102 (119). For example, the metadata server 104 encodes or records an indication of the client node 102 associated with the file A and the range of 4096 bytes from block 0. However, the metadata server 104 does not transmit the exclusive byte range token to the client node 102. Rather, the metadata server 104 tracks these exclusive byte range tokens for unbacked logical blocks or unallocated physical blocks. Such a configuration reduces lock management overhead and communication between clients and the metadata server. Also, such a configuration obviates token management on the client node and only requires the metadata server to perform the token management. The metadata server 104 allocates or causes to be allocated a physical block in a machine-readable medium (120) to back the logical block 0 for 4096 bytes for file A. A block can be representative of a section of the machine-readable medium that can be any size or any unit of storage. The machine-readable medium can be local or remote to the metadata server 104. If the client node 102 and/or the client node 106 have cached a translation of block 0 for file A prior to the allocation of the physical block, then that translation is invalidated. The metadata server 104 will provide the correct translation for block 0 of file A after allocation of the physical block (see 123 and 127 described below).

At some point after the write block 0 request by the client node 102 (see 114), the client node 106 also attempts to write to block 0 at the offset of 0 and having a length of 4096 bytes in the file A (122). This attempt to write to block 0 by the client node 106 is also at a time prior to release of a lock for accessing block 0 that would allow other nodes to access block 0.

After allocation of the physical block for block 0 (see 120), the metadata server 104 also transmits a message to the client node 106 (127). The messages include a command to invalidate the translation of file A, block 0. Accordingly, this new allocation clears any address ranges the client nodes had previously associated with block 0 of file A.

After receiving the message that includes the translation of block 0, the client node 102 writes data to block 0 (128). After writing data to block 0 of file A, the client node 102 transmits an update message back to the metadata server 104 to update the associated metadata for block 0 (132) and communicate that the client node 102 has performed the write to the newly allocated physical block. This update message of the metadata also informs the metadata server 104 that the write to the block is complete and the new file size based on the writing of the block. After the metadata server 104 updates metadata for the file A, the metadata server 104 releases the exclusive byte range lock granted to the client node 102.

At some point in time after receiving the shared write token on the whole file, the client node 106 requests a translation of file A, block 0 (130). In response, the metadata server 104 sends a message with the translation for file A, block 0 (134). However, the metadata server 104 does not transmit this translation until after the byte range is released (after the write(s) by the client node 102). After receiving the message that includes the translation of file A, block 0, the client node 106 writes data to file A, block 0 (136). Receipt of this translation is indicative to the client node 106 that the client node 106 is able to write to file A, block 0 and that file A, block 0 up to 4096 bytes has not been locked from access by other client nodes. After the byte range lock has been released by the metadata server 104, both the client node 102 and the client node 106 can continue to cache translation for file A, block 0 locally (138 and 140, respectively). This local updating by the client nodes can continue until another persistent snapshot is taken or invalidate message is received.

As shown by FIG. 1, the metadata server 104 manages the locking of regions of a file during a defined period when a new block(s) is to be allocated for the region(s). Client nodes do not receive byte range tokens for this region of the file during a time when the region is locked from access. Also, there is no locking of a region of a file during other times of write or read accesses.

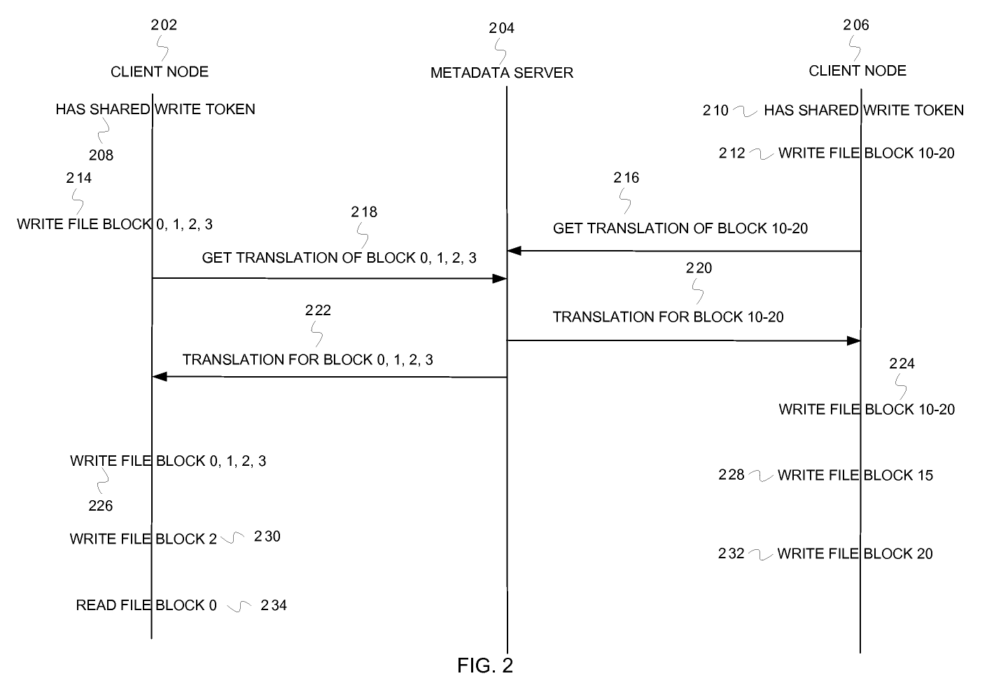

FIG. 2 is diagram illustrating message exchanges and operations among a metadata server and multiple nodes when there are concurrent accesses to different regions of a file from the multiple nodes in a clustered file system, according to some example embodiments.

Similar to FIG. 1, FIG. 2 includes a metadata server 204 for a clustered file system. The metadata server 204 allocates new backing blocks for files of the clustered file system. The metadata server 204 also manages metadata of the files of the clustered file system.

FIG. 2 also includes two client nodes (a client node 202 and a client node 206) that can concurrently access the files of the file system. The client nodes 202 and 206 can be representative of any type of client device (e.g., desktop computers, laptop computers, various mobile computing devices (such as, wireless Personal Digital Assistants (PDAs), wireless phones, etc.), etc.).

FIG. 2 illustrates, over time, a series of operations executing on and various messages between the metadata server 204, the client device 202 and the client device 206. In particular, time begins at the top of the diagram of FIG. 2. Time continues as the operations and messages descend down the diagram of FIG. 2. Therefore, in this example application, an operation 208 and an operation 234 are first and last in time, respectively.

At the beginning of this example, both the client node 202 and the client node 206 have a shared write token for a same file (208 and 210, respectively). The metadata server 204 had provided tokens to both the client node 202 and the client node 206 in response to the client node 202 and the client node 206 opening the file.

Next in time, the client node 206 writes to file blocks 10-20 of the file (212). Next in time, the client node 202 writes to file blocks 0, 1, 2, and 3 of the file (214). Accordingly, the two client nodes are concurrently writing to different regions of the same file. If the blocks are not locally cached in the client node 206, this write to file blocks 10-20 of the file causes the client node 206 to request a translation of the file blocks 10-20 from the metadata server 204 (216). Similarly if the blocks are not locally cached in the client node 202, this write to file blocks 0, 1, 2, and 3 of the file causes the client node 202 to request a translation of the file blocks 0, 1, 2, and 3 from the metadata server 204 (218).

In response to the request to get the translation from the client node 206, the metadata server 204 sends the translation for file blocks 10-20 to the client node 206 (220). This translation provides the location of the physical blocks that back the logical file blocks 10-20. In response to the request to get the translation from the client node 202, the metadata server 204 sends the translation for file blocks 0, 1, 2, and 3 to the client node 202 (222). This translation provides the physical location of the physical blocks that back the logical file blocks 0, 1, 2, and 3. For both 220 and 222, for this example, the metadata server 204 has already allocated the physical backing blocks. Otherwise, the metadata server 204 allocates prior to providing the translations.

The following operations at the client nodes 202 and 206 are examples of different reads and writes that can occur to different regions of a same file at a same time. The client node 206 writes to the file blocks 10-20 (224). The client node 202 writes to the file blocks 0, 1, 2, and 3 (226). The client node 206 writes to file block 15 (228). The client node 202 writes to file block 2 (230). The client node 206 writes to file block 20 (232). The client node 202 reads from file block 0 (234).

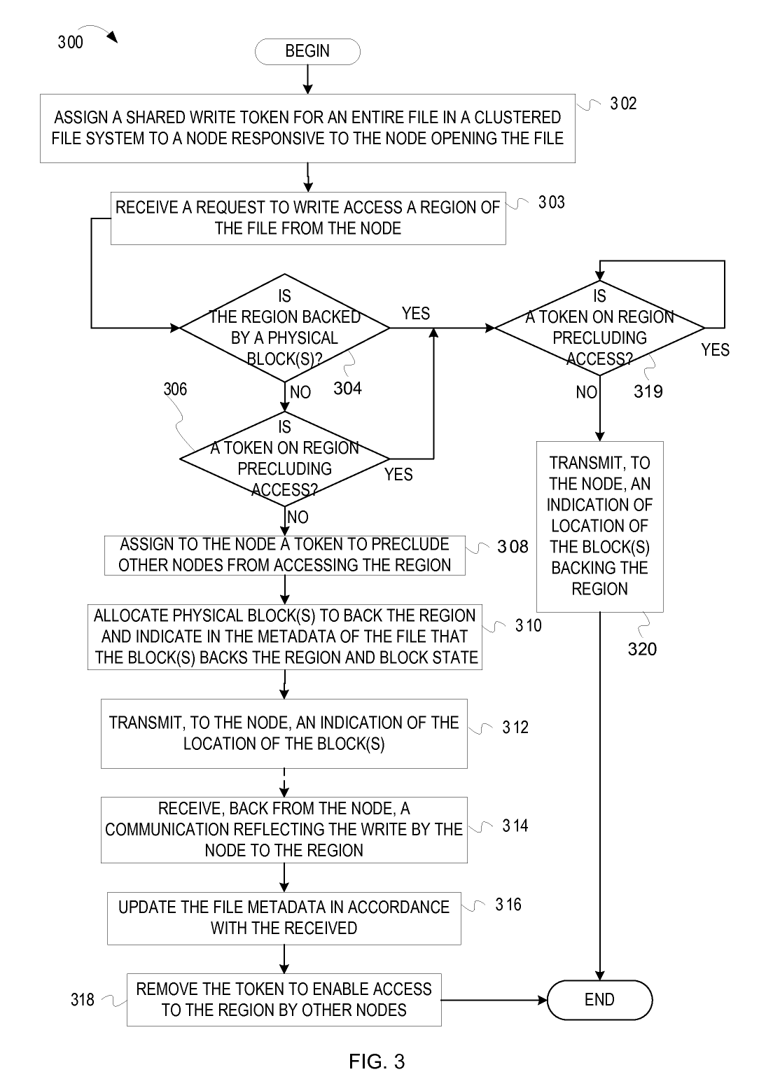

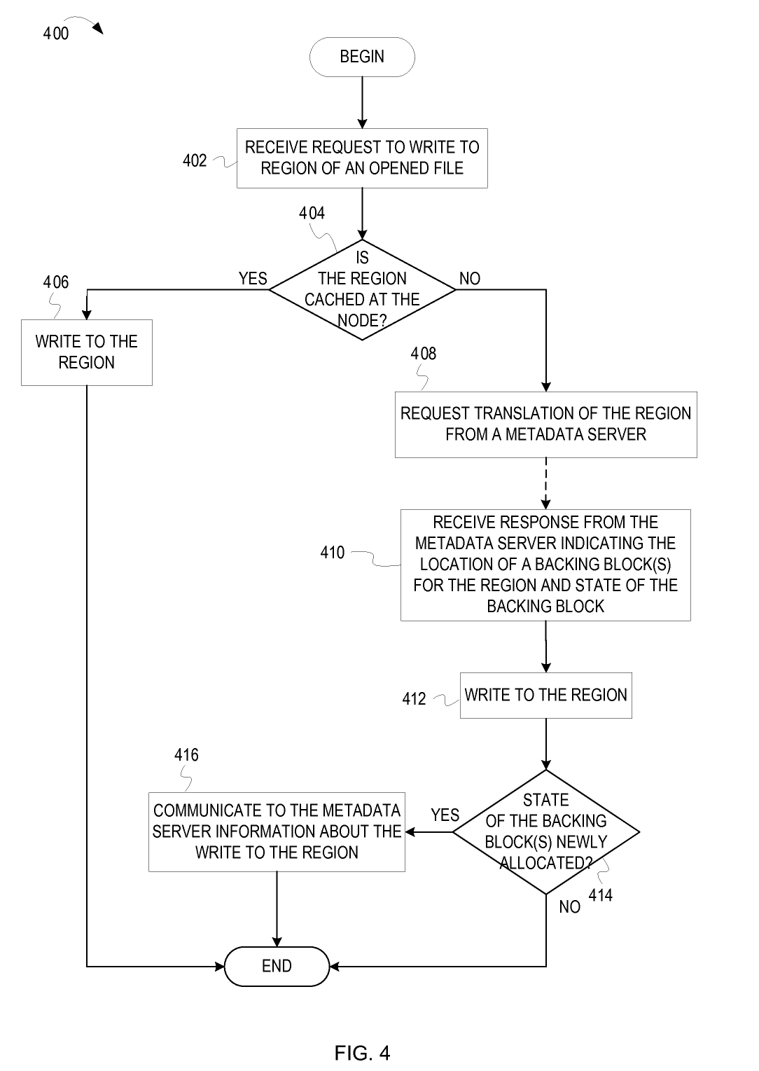

Operations for concurrent file I/O access are now described. In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flowchart. Two different flowcharts are now described. FIG. 3 illustrate operations for concurrent file I/O access from the perspective of a metadata server. FIG. 4 illustrates operations for concurrent file I/O access from the perspective of a client node. FIGS. 3-4 are described with reference to FIG. 1.

FIG. 3 is a flowchart illustrating operations for managing concurrent access to files of a clustered file system, according to some example embodiments. A flowchart 300 is described as being executed by a metadata server.

A metadata server assigns a shared write token for an entire file to a client node, in response to the client node opening the file (302). The shared write token is assigned to each node that is opening the file. Operations of the flowchart 300 continue to 303.

The metadata server receives a request to write access a region of a file from the client node (303). Operations of the flowchart 300 continue to 304.

The metadata server 104 determines whether a physical block(s) on a machine-readable medium backs the region that the client node is attempting to write access (304). For example, the client node could be appending a new set of data to the end of the file. Accordingly, no allocation of a physical block has been previously made for this region. If there is a physical block(s) backing the region, operations of the flowchart 300 continue at 320 (which are described in more detail below). Otherwise, operations of the flowchart 300 continue at 308.

The metadata server determines whether a byte range token precludes access to the region of the file (306). In particular, as further described below, a byte range token to preclude access is assigned for a region of a file during a time when a physical backing block is being allocated or has been recently allocated. Otherwise, accesses to unbacked regions by different client nodes at or near the same time can cause multiple allocations for a same region of a file. If access to the region is precluded, operations of the flowchart 300 continue at 319 (which are further described below). Otherwise, operations of the flowchart 300 continue at 308.

The metadata server assigns a token to the node for access of the region of the file while precluding other nodes from accessing the region (308). Accordingly, with the token for the region, only one allocation can be made for the region of the file. Operations of the flowchart 300 continue to 310.

The metadata server allocates (or causes to be allocated) physical block(s) in a machine-readable medium to back the region of the file and indicates in the file metadata that the physical block(s) backs the region (310). The metadata server also indicates state of the physical backing block(s) (e.g., newly allocated or previously allocated). The metadata server can allocate the physical block(s) on a local or remote machine-readable medium relative to itself. Operations of the flowchart 300 continue to 312.

The metadata server transmits, to the requesting client node, an indication of location of the physical block(s) allocated in the machine-readable medium (312). Operations of the flowchart 300 continue to 314.

Afterwards, the metadata server receives, back from the client node, A a communication reflecting the write(s) by the node to the region (314). For example, the client node can indicate a new size of the file resulting from the write by the client node. Operations of the flowchart 300 continue to 316.

The metadata server updates the metadata of the file in accordance with the communication from the client node (316). In addition, the metadata server updates state of the backing block(s) for the region to no longer indicate that the backing block(s) is newly allocated. Operations of the flowchart 300 continue to 318.

The metadata server removes the token indicated in the metadata for the file to enable access to the region by other client nodes (318). Operations for this path of the flowchart 300 are complete.

Returning to the point in the flowchart 300 where a determination was made that a physical block has been allocated for backing the region of the file (304) or that a determination was made that a token was already precluding access to the region (306), the metadata server determines whether a token still precludes access to the region (319). The token precluding access to the region exists for a limited time until the client node associated with the token informs the metadata server that data has been written to the allocated backing block(s) (i.e., the client node associated with the token has provided a metadata update). In some embodiments, the metadata server can delay responding to a client node requesting access to a file region associated with a token for a given period of time, and then check whether the token has been removed. In some embodiments, the metadata server can record indications of client nodes that request access while the token is on the file region. When the client node associated with the token responds with a metadata update and the token is removed, the metadata server can communicate the location of the physical backing block to the client nodes that have been waiting. Embodiments can also implement a timeout period to assume that an error has occurred in the client that has been granted the token for this range. If the timeout period expires, which suggests an error (e.g., the client node has crashed), the metadata server can perform operations to invalidate or clear the allocated backing blocks (e.g., clear any data written to the backing block or allocate a new backing block(s)), and grant a token to a waiting client node for the file region and communicate the new backing block(s) or the cleared already allocated backing block(s). If the region is not associated with a token, operations of the flowchart continue at 320.

The metadata server transmits, to the client node, an indication of the location of the backing block(s) for the region (320), which allows the client node to access the backing block(s) for the region. Hence, the region of a file is not locked if backed by a physical block(s). Operations of the flowchart 300 along this path are complete.

Operations for concurrent file I/O access from the perspective of a client node are now described. In particular, FIG. 4 is a flowchart illustrating operations, executed by a client node, for concurrent file I/O access, according to some example embodiments. A flowchart 400 is described as being executed by a client node.

A client node receives a request to write to a region of an opened file (402). The client node has already opened the file, so already possesses a shared token for the entire file. The request may originate from the operating system, or from a user.

The client node determines whether the region is cached at the client node (404). If the region is not locally cached, then control flows to 408. If the region is locally cached, then control flows to 406. The region will be cached when the client node has already accessed the region since opening the file, which also means that the region is backed.

If the region was determined to be accessible in cache, then the client nodes performs the write to the region (406). The flow ends from 406.

If the region was not locally cached, then the client node requests a translation of the region of the file from a metadata server that manages metadata for the file (408).

At some point soon thereafter, the client node receives a response from the metadata server indicating the location of a backing block(s) for the region and state of the backing block (410). The location information can comprise an address, an address range, a block number for a disk, and layout information. The state of the backing block(s) represents whether the portion of machine-readable storage medium (e.g., block or stripe) was newly allocated, which implies assignment of a token, or was already allocated.

The client node then writes to the region, which writes to the backing block(s) (412).

The client node then determines whether the communicated backing block state indicates that the backing block(s) was newly allocated (i.e., allocated responsive to the translation request from the client node) (414). If the state indicates that the backing block(s) was newly allocated, then control flows to 416. Otherwise, the flow ends.

If the state indicated that the backing block(s) was newly allocated, then the client node communicates to the metadata server information about the write to the region performed by the client node (416). For instance, the client node communicates a resulting size of the file to the metadata server. The flow ends after 416.

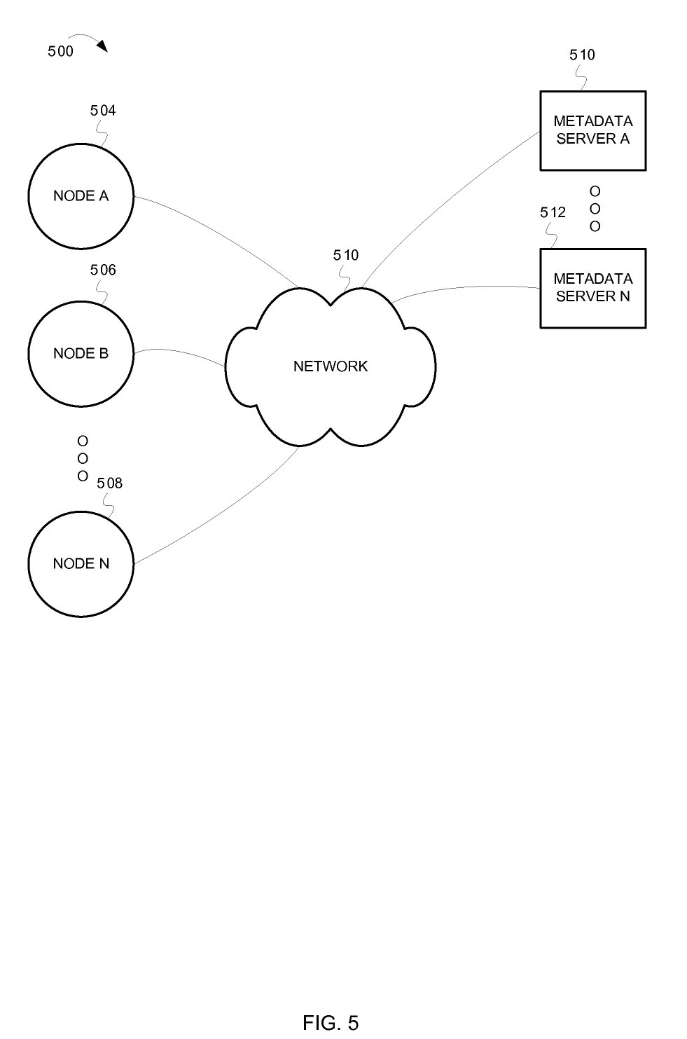

FIG. 5 is a block diagram of a clustered file system having concurrent access, according to some example embodiments. FIG. 5 illustrates a system 500 that includes a network 510 that communicatively couples together the other components of the system 500. A metadata server A 510 and a metadata server N 512 represent any number of servers that are used in the clustered file system to provide access to a number of different files to any number of client nodes (shown as a client node A 504, a client node B 506, and a client node N 508). As described above, a metadata server 502 allows for concurrent access of the files in the file system. In some example embodiments, a metadata server and a client can be running on a single physical node, wherein the server and the client are instances (processes or applications). Accordingly, in some configurations, each node can be both a client and a server. For example, the node A 504 can manage metadata for fileset A, while being a client for fileset B (wherein fileset B can be managed by metadata server N 512.

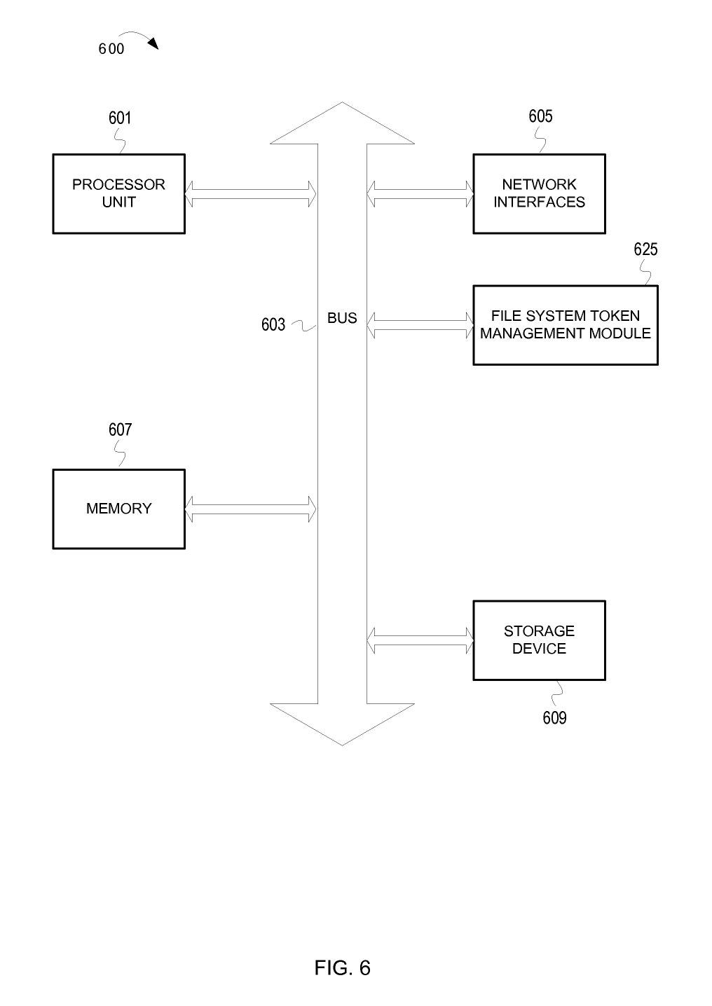

FIG. 6 is a block diagram illustrating a computer system, according to some example embodiments. FIG. 6 can be representative of the metadata server or one of the client nodes (as described above). A computer system 600 includes a processor unit 601 (possibly including multiple processors, multiple cores, multiple nodes, and/or implementing multi-threading, etc.). The computer system 600 includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system 600 also includes a bus 603 (e.g., PCI, ISA, PCI-Express, HyperTransport®, InfiniBand®, NuBus, etc.), a network interface 605 (e.g., an ATM interface, an Ethernet interface, a Frame Relay interface, SONET interface, wireless interface, etc.), and a storage device(s) 609 (e.g., optical storage, magnetic storage, etc.).

The computer system 600 also includes a file system token management module 625. If the computer system 600 is representative of a metadata server, the file system token management module 625 can perform the operations described above regarding managing concurrent access of regions of a file in a clustered file system (see FIG. 4). Any one of these functionalities may be partially (or entirely) implemented in hardware and/or on the processing unit 601. For example, the functionality may be implemented with an application specific integrated circuit, in logic implemented in the processing unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601, the storage device(s) 609, and the network interface 605 are coupled to the bus 603. Although illustrated as being coupled to the bus 603, the memory 607 may be coupled to the processor unit 601.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the embodiments are described with reference to various implementations and exploitations, it will be understood that these embodiments are illustrative and that the scope of the inventive subject matter is not limited to them. In general, techniques for optimizing design space efficiency as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining that a region of a file is not backed by a portion of a machine-readable storage medium for a file system mounted on a plurality of nodes, said determining responsive to a first node of the plurality of nodes requesting write access to the region of the file, wherein the file has already been opened by the first node;
obtaining a portion of a set of one or more machine-readable storage media to back the region of the file responsive to said determining that the region of the file was not backed by a portion of a machine-readable medium;
indicating that the first node has exclusive write access to the region of the file and that the portion of the set of one or more machine-readable storage media are newly allocated;
communicating to the first node location of the portion of the set of one or more machine-readable storage media allocated to back the region of the file;
refraining from providing location of the portion of the set of one or more machine readable-storage media that backs the region to others of the plurality of nodes while the first node is indicated as having write access to the region and the portion of the set of one or more machine-readable storage media that backs the region are indicated as newly allocating; and
indicating that the first node no longer has exclusive write access to the region of the file and that the portion of the set of one or more machine-readable storage media that back the region are not newly allocated responsive to receiving a communication from the first node that the first node has written to the region of the file.

2. The method of claim 1, wherein said indicating that the first node has exclusive write access to the region of the file comprises modifying metadata of the file to indicate a byte range token for the region and to indicate the first node.

3. The method of claim 2, wherein said indicating that the first node no longer has exclusive write access to the region of the file comprises updating the metadata of the file to release the byte range token.

4. The method of claim 1, wherein said refraining from providing location of the portion of the set of one or more machine readable-storage media that backs the region to others of the plurality of nodes comprises refraining from providing a translation of the region to the other nodes.

5. The method of claim 4 further comprising:
recording an indication of a second node of the plurality of nodes that requests a translation of a second region of the file that at least partially overlaps with the region of the file;
providing the translation to the second node after receiving the communication from the first node that the first node has written to the region of the file.

6. A method comprising:
transmitting, to a server and from a node of a plurality of nodes within a clustered file system provides concurrent file input/output (I/O) access for a plurality of files, to write access a region of a file of the plurality of files;
receiving, back from the server and by the node, an authorization to write access the region without a lock to preclude access of the region by other nodes of the plurality of nodes, if at least one physical section in a machine-readable medium has been allocated for storage of the region by the server;
receiving, back from the server and by the node, the authorization to write access the region with the lock to preclude access of the region by the other nodes, if the at least one physical section in the machine-readable medium has not been allocated for storage of the region by the server; and
responsive to receiving the authorization to write access,
transmitting, to the server and from the node, data for storage into the at least one physical section in the machine-readable medium.

7. The method of claim 6, wherein the receiving of the authorization to write access the region without the lock comprises receiving the authorization to write access to the region without receiving an exclusive byte range token for the region of the file from the server.

8. The method of claim 6, wherein the receiving of the authorization to write access the region with the lock comprises receiving the authorization to write access to the region without receiving an exclusive byte range token for the region of the file from the server.

9. The method of claim 6, further comprising responsive to transmitting the request to write access the region of the file, receiving from the server a shared write token for the file.

10. The method of claim 6, wherein the at least one physical section comprises at least one physical block.

11. A computer program product for concurrent access of a plurality of files, the computer program product comprising:
a computer readable storage medium having computer readable program code embodied therewith, the computer readable program code configured to,
receive a request to write access a region of a file of the plurality of files from a node of a plurality of nodes within a clustered file system, the clustered file system providing concurrent file input/output (I/O) access for the plurality of files;
responsive to determining that at least one physical section of a machine-readable medium has been allocated for storage of the region of the file, authorize the write access to the region of the file without locking the region to preclude other nodes of the plurality of nodes from access to the region;
responsive to determining that the at least one physical section of the machine-readable medium has not been allocated for storage of the region of the file and that the region is not locked from access,
allocate the at least one physical section in the machine-readable medium for storage of the region of the file;
assign a lock for access of the region to the node, wherein the assigning of the lock for access precludes other nodes of the plurality of nodes from accessing the region;
transmit, to the node, an address range of the at least one physical section in the machine-readable medium;
receive, back from the node, metadata for storage into the at least one physical section in the machine-readable medium; and
release the lock to enable access to the region by other nodes of the plurality of nodes, after storing the metadata into the at least one physical section in the machine-readable medium.

12. The computer program product of claim 11, wherein the computer readable program code is configured to authorize access, by the node and at least one other node of the plurality of nodes, to the region without assignment of the lock for access of the region to the node and the at least one other node, after allocation of the at least one physical section in the machine-readable medium and after release of the lock to enable access.

13. The computer program product of claim 12, wherein after allocation of the at least one physical section in the machine-readable medium and after release of the lock to enable access, the computer readable program code is configured to perform the following without assignment of the lock for access,
receive an update, from the node and the at least one other node, to the region; and
store the update into the at least one physical section in the machine-readable medium.

14. The computer program product of claim 11, wherein responsive to receipt of the request to write access the region of the file, the computer program code is configured to transmit to the node a shared write token for the file.

15. The computer program product of claim 11, wherein the at least one physical section comprises at least one physical block.

16. An apparatus comprising:
a processor that is part of a node of a plurality of nodes;
an access module executable on the processor, the access module configured to,
transmit, to a server within a clustered file system that provides concurrent file input/output (I/O) access for a plurality of files, to write access a region of a file of the plurality of files;
receive, back from the server, an authorization to write access the region without a lock to preclude access of the region by other nodes of the plurality of nodes, if at least one physical section in a machine-readable medium has been allocated for storage of the region by the server;
receive, back from the server, the authorization to write access the region with the lock to preclude access of the region by the other nodes, if the at least one physical section in the machine-readable medium has not been allocated for storage of the region by the server; and
responsive to receipt of the authorization to write access with the lock, transmit, to the server, metadata associated with the data for storage into the at least one physical section in the machine-readable medium.

17. The apparatus of claim 16, the access module is configured to receive the authorization to write access the region without the lock, without receipt of an exclusive byte range token for the region of the file from the server.

18. The apparatus of claim 16, the access module is configured to receive the authorization to write access the region with the lock, without receipt of an exclusive byte range token for the region of the file from the server.

19. The apparatus of claim 16, wherein the access module is configured receive from the server a shared write token for the file, in response to transmission of the request to write access the region of the file.

20. The apparatus of claim 16, wherein the at least one physical section comprises at least one physical block.
